(19) United States
(12) Patent Application Publication
(10) Pub. No.: US 2017/0108904 A1
(43) Pub. Date: Apr. 20, 2017

(54) LOCATION BASED ELECTRIC POWER MANAGEMENT METHOD AND SYSTEM THEREOF

(71) Applicant: AICT, Gyeonggi-do (KR)

(72) Inventors: Jung In CHOI, Gyeonggi-do (KR); Mi Jeom KIM, Gyeonggi-do (KR); Jae Weon YOON, Gyeonggi-do (KR)

(73) Assignee: AICT, Gyeonggi-do (KR)

(21) Appl. No.: 15/035,834

(22) PCT Filed: May 13, 2015
(86) PCT No.: PCT/KR2015/004784

§ 371 Date: May 11, 2016

(30) Foreign Application Priority Data
Apr. 10, 2015 (KR) 10-2015-0050922
Apr. 10, 2015 (KR) 10-2015-0050931

(51) Int. Cl. G06F 1/26; G06F 1/30

(52) U.S. Cl. CPC G06F 1/266; G06F 1/305

(57) ABSTRACT

The present disclosure is related to an electric power management system includes a power management server, an access point configured to communicate with the power management server and to have an address and an ID, a measurement device connected to the access point and configured to have an ID, and a user terminal configured to be connected to the access point and to communicate with the power management server, and the electric power management method thereof.

### FIELD

The present invention relates to a location based electric power management method and system thereof and, more particularly, to a technology relating to a location based electric power management method and system through which users can autonomously reduce the amount of electric power used using a power measurement device capable of connecting to a communication network and a terminal, such as a smart phone or a computer.

### BACKGROUND

A background technology relating to this disclosure is disclosed, which does not mean only a known technology.

An electric power supplier operates a demand response (DR) service in order to induce customers to reduce the amount of electric power when the amount of electric power reaches a peak. In accordance with such a service, a supplier notices a peak amount of electric power, and customers who have received the notice message reduce the amount of electric power used. In this case, the supplier compensates the customers for the amount of electric power reduced in a certain form. More specifically, for example, if the amount of electric power is expected to be a peak or the amount of electric power is a peak in the summertime or wintertime, an electric power exchange issues a DR signal (i.e., a reduction command). In response thereto, service providers participating in the DR business send electricity reduction messages according to the DR signal to customers managed by the service providers. Profits obtained by a reduction of electricity are subsequently settled for customers who have reduced electric power in response to the electricity reduction messages. In order to manage electric power, the system of a supplier is managed using such a method. In such a system, however, information about a reduction of electricity is not properly delivered to each of customers, and each customer is autonomously unable to know how information moves, reaching a limited effect.

Korean Patent Application Publication No. 10-2013-0073464 shown in FIG. 1 discloses an apparatus and method in which an energy service interface (ESI) 11, that is, an interface with an external energy supplier 10, or a meter is notified of a function capable of being controlled by smart household appliances 12 and 13 for an energy reduction and the smart household appliances 12 and 13 are directly controlled for an energy reduction if a specific condition is satisfied according to priority set by a user. In accordance with the prior art, a user 15 reduces electric power by directly controlling the smart household appliances 12 and 13 within a permitted range in the situation in which electric power supply and demand are not sufficient, thereby being capable of preventing large-scale blackout. Furthermore, from the standpoint of the user 15, the worst blackout situation can be prevented and the continuity of energy providing can be guaranteed when electric power supply and demand are not sufficient because the energy supplier 10 has the right to control the smart household appliances 12 and 13 within a permitted range. However, the prior art is problematic in that it requires additional elements, such as a wall pad 14 at home and the ESI 11 with the energy supplier 10 and electrical devices at home, and electric power can be reduced only within a limited range (i.e., a range permitted by the user). Furthermore, the prior art has a problem in that it is difficult to be realized because a system installation cost is high compared to direct profits through a reduction of electricity.

### DISCLOSURE

### Technical Problem

This is described at the end of “DETAILED DESCRIPTION.”

### Technical Solution

In this paragraph, an overall summary of this disclosure is provided, which should not be construed as limiting the denotation of this disclosure.

In an aspect of this disclosure, there is provided an electric power management system, including a power management server, an access point configured to communicate with the power management server and to have an address and an ID, a measurement device connected to the access point and configured to have an ID, and a user terminal configured to be connected to the access point and to communicate with the power management server wherein the power management server includes an event transmission unit configured to send an electric power management event message to the user terminal and an information reception unit configured to receive, from the user terminal, control information of a user and information about the address and ID of the access point connected to the user terminal.

### Advantageous Effects

The advantageous effects of the present disclosure will be described at the end of “DETAILED DESCRIPTION.”

### DESCRIPTION OF THE DRAWINGS

FIG. 1 is a diagram showing a conventional power grid system disclosed in Korean Patent Application Publication No. 10-2013-0073464;

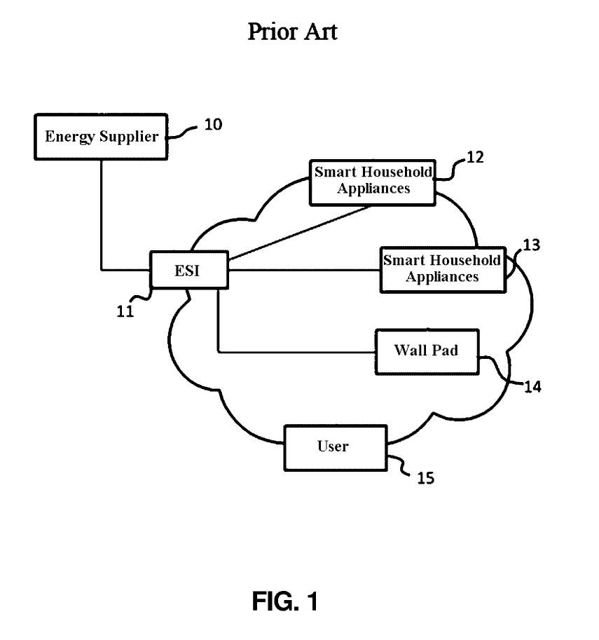

FIG. 2 is a diagram showing a location based electric power management system according to an embodiment of this disclosure;

FIG. 3 is a diagram showing a location based electric power management system according to another embodiment of this disclosure;

FIG. 4 is a diagram showing a power management server and a movement of data according to an embodiment of this disclosure;

FIG. 5 is a diagram showing a user terminal, the power management server, a measurement device, and a flow of data according to an embodiment of this disclosure;

FIG. 6 is a diagram showing a communication method between an access point, the measurement device, and the user terminal according to another embodiment of this disclosure;

FIG. 7 is a diagram showing an electric power management system including an environment measurement device according to another embodiment of this disclosure;

FIG. 8 is a diagram showing the power management server using the environment measurement device and a movement of data according to another embodiment of this disclosure; and

FIG. 9 is a diagram showing an electric power management system in which the power measurement device and the environment measurement device are mixed according to another embodiment of this disclosure.

### DETAILED DESCRIPTION

Embodiments of this disclosure are described in detail with reference to the accompanying drawings.

In an electric power management system, an electric power supplier 200 includes a power grid for supplying electric power to demanders. The electric power supplier 200 includes a power management server 201 for monitoring and managing an electric power situation of the power grid. A plurality of lower groups to which electric power is supplied stepwise may be formed within the power grid. In general, there may be a service provider designated by the electric power supplier 200 and customers subscribed to the service provider, and the customers may have final user groups 202 and 203. The customers and the final user groups 202 and 203, for example, common houses are finally supplied with electric power.

Each of the final user groups 202 and 203 may collect electric power data measured by a measurement device to know the amount of electric power used or may collect data related to a change in the environment of a specific space, for example, a temperature change and an illumination change, that is, another numerical value indicative of electric power. Furthermore, the final user groups 202 and 203 of the electric power management system may include an access point (AP) 210 which can be connected to the power management server 201 by the Internet or its own infrastructure and which has a unique address and an ID. Accordingly, the measurement device is connected to the access point 210, may have a unique ID, and may send measured data to the power management server 201. Furthermore, the final user groups 202 and 203 may include one or more user terminals 240 capable of communication with the power management server 201.

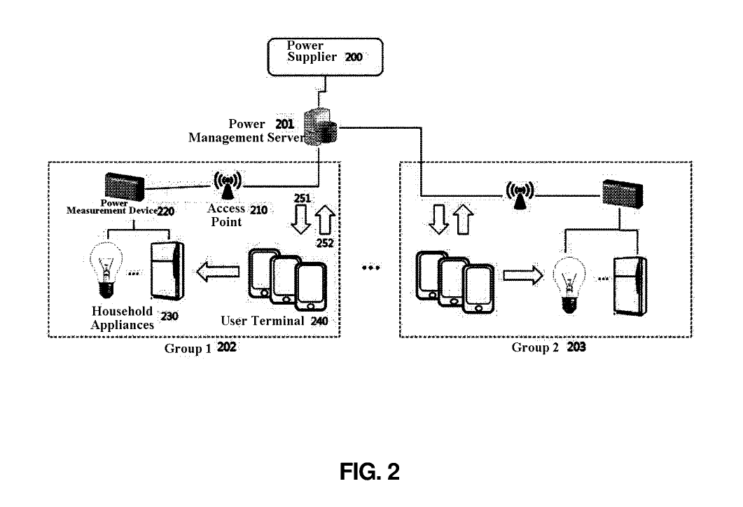

FIG. 2 shows an embodiment in which the measurement device is a power measurement device 220. The power measurement device 220 installed in the final user groups 202 and 203 may perform communication through the Internet and have a wireless communication function. The power measurement device 220 may be a smart meter improved from a current electricity meter at home so that the smart meter can perform communication. The power measurement device 220 may send information about the amount of electric power used by the final user groups 202 and 203 and optionally, may receive information from the supplier 200 and process requested contents.

When the power measurement device 220 is installed in the power grid, the ID of the power measurement device 220 and the ID and MAC address of the access point 210 used by the power measurement device 220 are registered with the power management server 201. The IDs and media access control (MAC) address may be directly registered by a user when the user installs a corresponding program or may be registered by a Plug and Play function for automatically sending information when the power measurement device 220 is installed.

When the power measurement device 220 is installed as described above, the power management server 201 can be aware of the amount of electric power used within the final user groups 202 and 203 through the power measurement device 220, can collect data, and can analyze the collected data. Furthermore, the power management server 201 can specify the location of the power measurement device 220 based on information about the access point 210 specified when the power measurement device 220 is installed.

The access point 210 has its own MAC address and ID. The access point 210 can specify its location on a communication network using the MAC address and ID. Furthermore, the power measurement device 220 connected to the access point 210 can also be additionally specified. The communication network may be a network according to infrastructure itself of a power grid service provider or may be a network according to the Internet. The access point 210 is not limited to any one of wired or wireless access points. If the access point 210 is wireless, it may connect wireless devices to a wired network using industry standards, such as Wi-Fi, Bluetooth, and Zigbee. In general, the wireless access point 210 is connected to a router for relaying a wired network and may relay data between wireless devices, such as various mobile devices, for example, a computer, a printer, and a smart phone and wired devices on a network.

Furthermore, the access point 210 may have a password set by a user. In this case, only the user who has the password and who is permitted can obtain information about the access point 210 and may send event result information 252 to the power management server 201.

The user terminal 240 may be various devices capable of communication, such as a specific terminal installed by the supplier 200 or a smart phone, a pad type computer, or a notebook being used by a user. A location based participation application program (App) that enables the user terminal 240 to communicate with the power management server 201 is installed in the user terminal 240. The App may receive an event message 251 transmitted by the power management server 201 and display the event message to a user. The user may control or reduce the use of electric power based on the contents of the event message received through the App. The user who has participated in a corresponding event sends the event result information 252 to the power management server 201. The event result information 252 includes control information according to the event request of the user and the ID and address of the access point 210 used by the power measurement device 220 of the final user groups 202 and 203 to which the user belongs. Accordingly, the user who has participated in the event may send the location when the user participated in the event to the power management server 201 using information about a corresponding access point. The power management server 201 may calculate the amount of electric power controlled or reduced by the event and compensate the user for the amount of electric power controlled or reduced.

A user may check the MAC address and ID of the access point 210 to which the power measurement device 220 is connected and directly input an MAC address and ID through the location based participation App. In some embodiments, it is automatically checked whether the power measurement device 220 has been connected to a corresponding access point 210 through the access point 210.

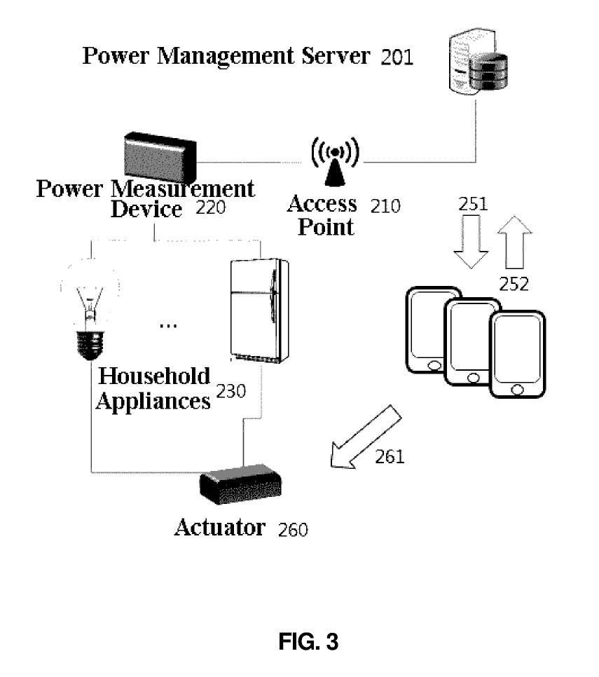

A user can directly turn off household appliances 230 or reduce the amount of electric power used in order to control electric power. An additional method for enabling a user to control electric power is described with reference to FIG. 3. The household appliances 230 installed in each of the final user groups 202 and 203 may include an actuator 260 that enables the household appliances 230 to be controlled. The actuator 260 is connected to the power unit or power management unit of the household appliances 230 so that a user can control the amount of electric power used by the household appliances 230 through the actuator 260. The actuator 260 may have a wireless communication function, such as Wi-Fi. Accordingly, a user may selectively register the ID of the actuator 260 and the ID and MAC address of an access point being used by the actuator 260 with the power management server 201 through the access point 210 using the wireless communication function. Furthermore, Plug and Play installation may be possible as in the power measurement device 220. In some embodiments, a user may directly register the ID of the actuator 260 to be used by him or her with the power management server 201. The power management server 201 manages a table in which the power measurement devices 220 using the same access point 210 and one or more actuators 260 are mapped. The actuator 260 enables a user to control the household appliances 230 more easily. The location based participation App has a function capable of controlling the actuator 260. Accordingly, a user can control the amount of electric power of the household appliances 230 although the user is placed outside the area of the final user groups 202 and 203. The number of household appliances 230 controlled by the actuator may be one or more.

The location based participation App may display a list of the IDs of one or more actuators 260 within the same area of the access point 240 when it is first driven. The ID of an actuator to be used by a user may be registered with the App. After participating in a reduction of electricity through the actuator in response to the event message 251, the user may send information, indicating that the user has participated in a corresponding event, along with the ID (i.e., name and MAC address) of the actuator used by the user.

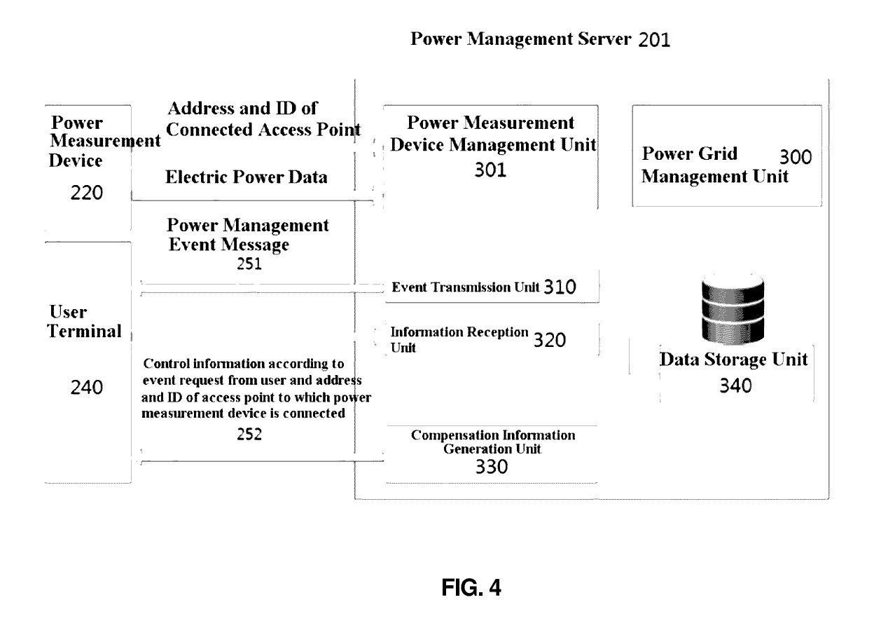

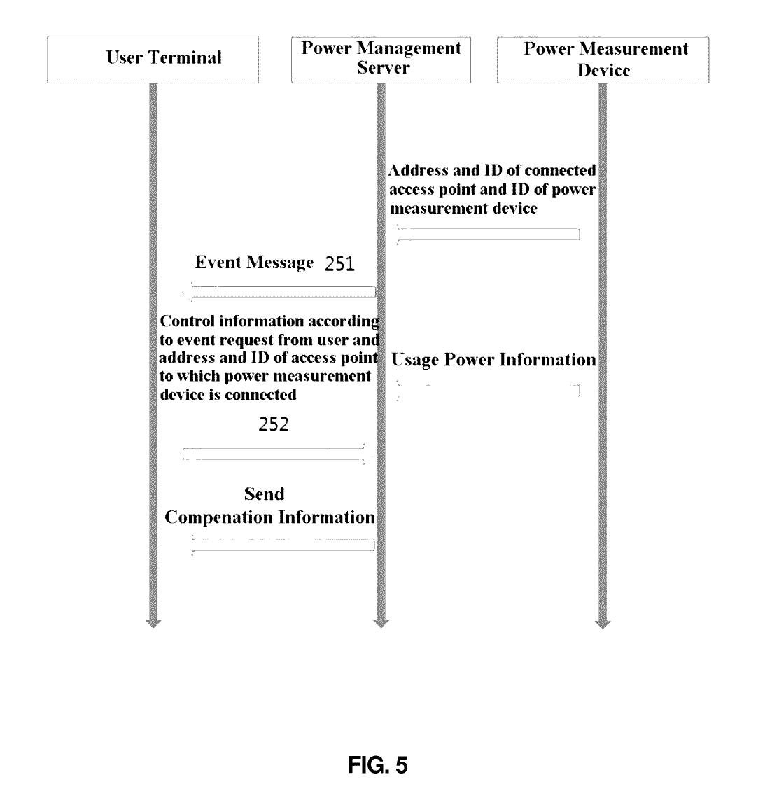

The configuration of the power management server 201 for managing the amount of electric power used by the final user groups 202 and 203 in the system configured as described above and the exchange of data are described with reference to FIGS. 4 and 5. First, the power management server 201 receives the address and ID of the access point 230 connected thereto and the ID of the power measurement device 220 from the power measurement device 220 and stores them. The power management server 201 may send the event message 251 to each user terminal 240 if an electric power management event (e.g., a reduction of electricity attributable to an electricity peak) is required. Users who have the user terminals 240 may perform behaviors for a reduction of electricity in response to the event message 251. For example, if an electricity peak state is reached due to the excessive use of coolers in the summertime, the power management server 201 sends the event message 251 regarding a reduction of electricity (i.e., a demand response (DR)) to the users. Each of the users performs a corresponding event at their locations and notifies the power management server 201 of the results of the execution. The contents of the event results may include turning off power to specific household appliances 230 or reducing the amount of electric power used. The power management server 201 generates compensation contents for the number of persons who have participated in the event using the number of persons participated in the event and the results measured by the power measurement device 220. The compensation may be points or cash designated by a system service provider. The power management server 201 may determine whether the data of the access point 210 transmitted by a user is identical with the data of the access point 210 of the power measurement device 220 before the compensation is performed.

The power management server 201 includes a power measurement device management unit 301 for receiving information about the power measurement device 220, an event transmission unit 310 for sending the event message 251 for electric power management to the user terminal 240, and an information reception unit 320 for receiving user control information and information 252 about the access point 210 from the user terminal 240. Furthermore, the power management server 201 includes a compensation information generation unit 330 for generating user compensation information determined based on event results. In this case, pieces of generated and exchanged information are stored in a data storage unit 340.

The compensation information generation unit 330 of the power management server 201 may generate the basic amount of electric power (i.e., a customer base line (CBL)) of the final user groups 202 and 203 using data received from the power measurement device 220 registered with the power management server 201 and store the CBL in the data storage unit 340. When the power management server 201 generates an event related to a reduction of electricity, the compensation information generation unit 330 determines the amount of electric power controlled by the event by comparing the amount of electric power controlled by the event with the value of the CBL.

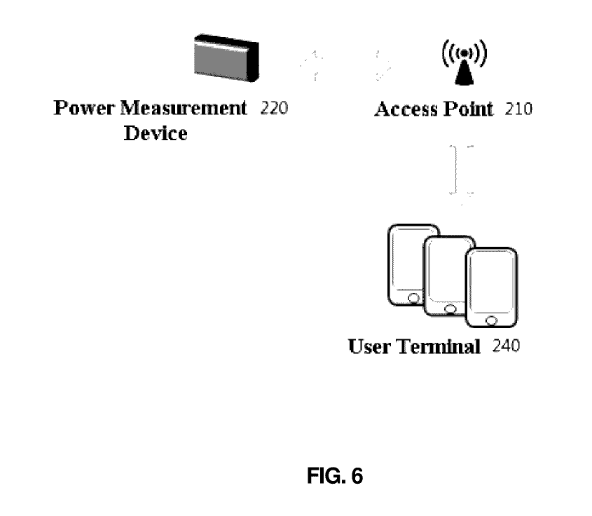

A method for checking, by the user terminal 240, the power measurement device 220 through the location based participation App is described with reference to FIG. 6. The user terminal 240 accesses the access point 210 to which the user terminal 240 can be connected and checks whether the power measurement device 220 is also connected to the access point 210. The user of the user terminal 240 may check whether the power measurement device 220 is a power measurement device placed in the area where the user performs an event and may automatically send information about the checked access point 210 when sending event results.

The location based program of the user terminal may operate according to the sequence of the following method.

P1) Check the address and ID of the access point 210 to which the user terminal is connected

P2) Check whether the power measurement device 220 connected to the access point is present and the ID of the power measurement device 220

P3) Receive an event message 251 from the power management server 201

P4) Display the event message on a screen

P5) Receive event results (i.e., control information) from the user

P6) Send (252) the control information and the address and ID of the access point 210 to which the user terminal has been connected to the power management server 201

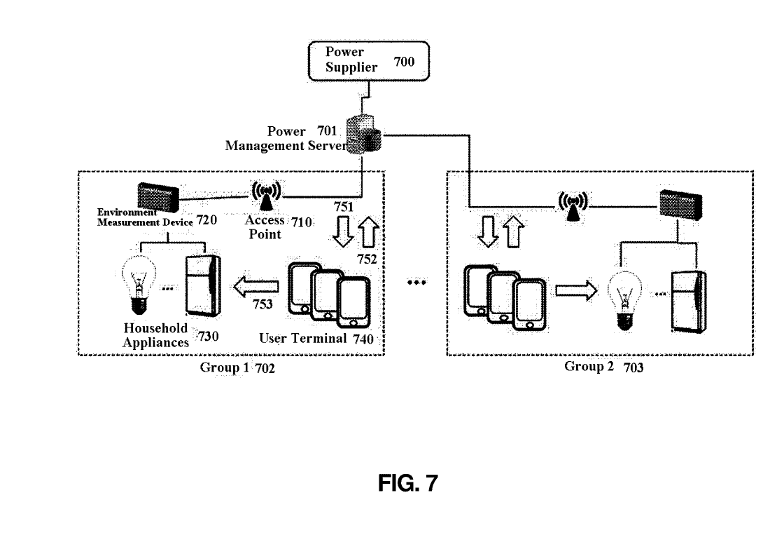

FIG. 7 illustrates an embodiment in which the measurement device is an environment measurement device 720 for detecting information related to an environment in a specific space. The environment measurement device 720 installed in final user groups 702 and 703 may access the Internet, may perform communication, and may have a wireless communication function. The environment measurement device 720 may be a smart thermometer. The environment measurement device 720 continues to detect and monitor a temperature within a specific space. Information detected as described above may be processed by the environment measurement device 720 or may be transmitted to and stored in the power management server 201 without any change.

When the environment measurement device 720 is installed in a power grid or the Internet, the ID of the environment measurement device 720 and the ID and MAC address of an access point 710 used by the environment measurement device 720 are registered with a power management server 701. The IDs and media access control (MAC) address may be directly registered by a user when the user installs a corresponding program or may be registered by a Plug and Play function for automatically sending information when the power measurement device 720 is installed.

The environment measurement device 720 may be a smart thermometer or a smart illumination detection device. The environment measurement device 720 and household appliances 730 are also placed in a specific space within the final user groups 702 and 703. If the environment measurement device 720 is a smart thermometer, the environment measurement device 720 measures a temperature within the specific space. The household appliances 730 related to air conditioning and heating may be placed in the specific space. A temperature change is generated depending on whether the household appliances 730 are driven or not and the degree of the household appliances 730 that are being driven. Such a temperature change may be detected by the smart thermometer continuously or intermittently and may be stored in memory within the smart thermometer or in the data storage unit 840 of the power management server 701.

If the environment measurement device 720 is a smart illumination device, the environment measurement device 720 may detect an illumination change according to light within the specific space. The household appliances 230 related to lights may be placed in the specific space. The amount of light measured by the smart illumination device may be different depending on whether the household appliances 230 are driven or not and the degree of the household appliances 730 that are being driven. As in the thermometer, detected data may be stored in memory within the smart illumination device or in the data storage unit 840 of of the power management server 701.

When the environment measurement device 720 is installed as described above, the power management server 701 may be aware of the amount of electric power used in the final user groups 702 and 703 or information for estimating the amount of electric power used the environment measurement device 720 or both through the environment measurement device 720 and may collect and analyze the data. Furthermore, the power management server 701 may specify the location of the environment measurement device 720 based on information about the access point 710 specified when the environment measurement device 720 is installed.

The location based participation App of the access point 720 and the user terminal 740 has the same function as that described above.

An additional method for controlling, by a user, electric power if the environment measurement device 720 is used is generally the same as the embodiment of the power measurement device. The actuator 760 operates in the same manner as that described in connection with the previous embodiment. If control of a public place or a space used by several persons is required, the participation of users who are not connected to an access point or who are not placed in a specified space may be limited. Rights to access the actuator may not be given to the users.

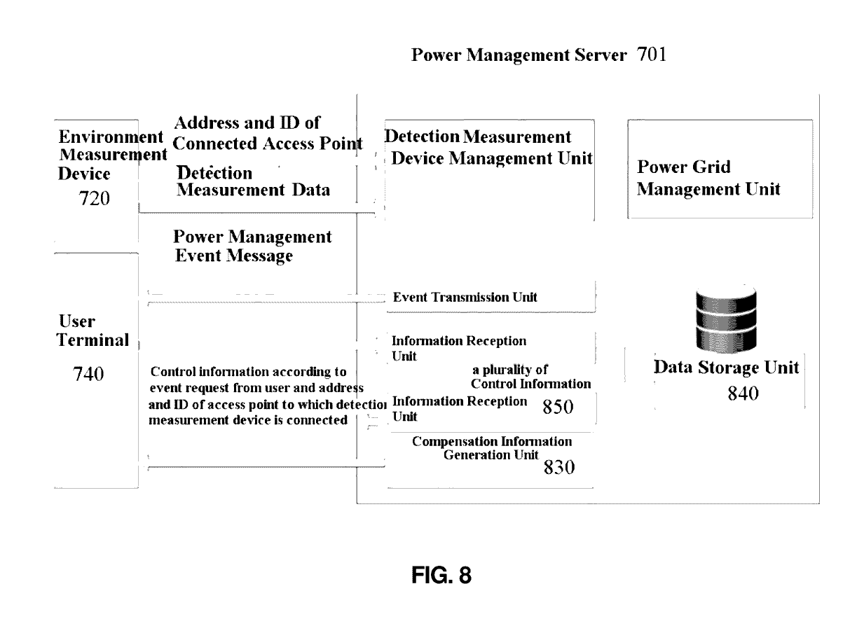

FIG. 8 is a flow of data in the system including the environment measurement device 720. In general, the power management server 701 operates in the same manner as that described in connection with the previous embodiment. If a temperature or illumination needs to be controlled in a public place or a space used by several persons, a process for deriving the persons' opinions may be required. To this end, the power management server 701 may include a consultation module 850. If a plurality of users wants to control a temperature or illumination based on a specific access point 710, the consultation module 850 receives control values from the plurality of users and derives a consulted value from the received control values. Such a consultation derivation method may include the mean for all the opinions, the decision of the majority, or a calculation method recommended by an electric power supplier 700. The derived consultation value is delivered to the user terminal 740, the environment measurement device 720, or an actuator and is used to control a temperature or illumination within the specific space. The consultation module 850 may not be placed in a server, but may be placed in the user terminal 740 or the actuator.

The compensation information generation unit 830 of the power management server 701 may convert data, received from the environment measurement device 720 registered with the power management server 701, into the estimated amount of electric power, may generate the customer base line (CBL) of the final user groups 702 and 703 using the estimated amount of electric power, and may store the CBL in the data storage unit 840. In some embodiments, the compensation information generation unit 830 may generate a CBL using temperature or illumination data without change. When the power management server 701 generates an event related to a reduction of electricity, the compensation information generation unit 830 determines the amount of electric power controlled by the event by comparing the amount of electric power controlled by the event with a CBL.

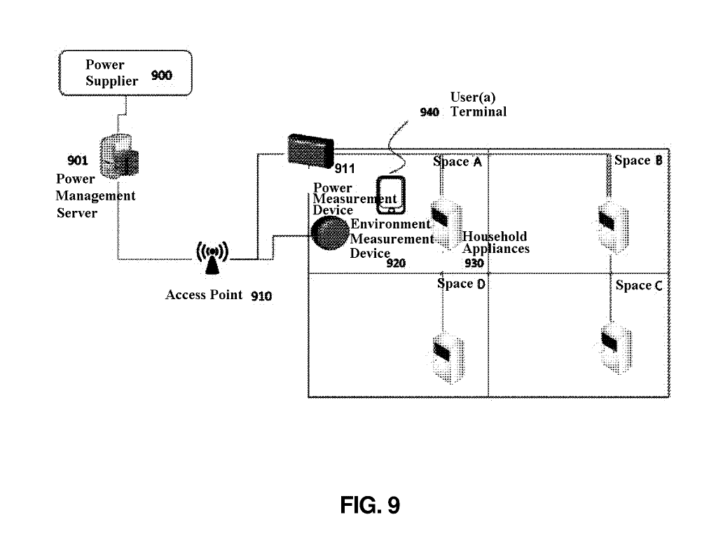

FIG. 9 is a diagram showing yet another embodiment of the disclosure. In an electric power management system of FIG. 9, a single power measurement device 911 is connected to household appliances 930 divided into several spaces A, B, C, and D and may measure only a total amount of electric power consumed. The user “a” of the individual space A has reported control information “info1” about a reduction of electricity, but it is necessary to verify whether the report is genuine or not. To this end, the electric power management system may include an environment measurement device 920 for measuring a change of a space environment, such as a thermometer or illumination detection device capable of accessing an access point 910 in the space A. When first installed, the power measurement device 911 may selectively send its own ID, the address and ID of the access point 910 connected to the power measurement device 911, and information about the environment measurement device 920 in the same space to a power management server 901. The power management server 901 may store the received information. The environment measurement device 920 may send measured information to the power management server 901 through the access point 910. In accordance with such a system, when the terminal 940 of the user “a” sends control information (e.g., information related control, such as control of a temperature of an air-conditioner or a reduction of brightness of a light) about the household appliances 930 in response to an event message, the power management server 901 may verify whether an environment, such as a temperature or illumination, has been actually generated by such control based on information measured by the environment measurement device 920 and may properly compensate the user “a” for such a change. The related information may also be delivered to the compensation information generation unit of the power management server 901.

In accordance with the systems and methods of the disclosure, a system for an effective demand response (DR) service that motivates each user can be constructed because electric power can be controlled and a user who has actually participated in an event can be compensated for. That is, in a prior art, compensation is made based on the amount of electric power reduced for each building or factory. In contrast, in the system of this disclosure, electric power can be controlled in a smaller unit by floor or house. Furthermore, each user who actually participates in an event can be compensated for within the area covered by each access point 210.

Various embodiments according to this disclosure are described below.

(1) An electric power management system includes a power management server, an access point configured to communicate with the power management server and to have an address and an ID, a measurement device connected to the access point and configured to have an ID, and a user terminal configured to be connected to the access point and to communicate with the power management server. The power management server includes an event transmission unit configured to send an electric power management event message to the user terminal and an information reception unit configured to receive control information of a user from the user terminal and information about the address and ID of the access point connected to the user terminal.

(2) In the electric power management system, the measurement device automatically sends the ID of the measurement device and the address and ID of the access point to the power management server when the measurement device is installed.

(3) The electric power management system further includes an actuator connected to the access point and driven by the user terminal.

(4) In the electric power management system, the measurement device includes a power measurement device.

(5) In the electric power management system, the measurement device includes an environment detection device.

(6) In the electric power management system, the power management server further includes a compensation information generation module configured to generate user compensation information using the control information, the address and ID of the access point, and electric power information received from the measurement device.

(7) In the electric power management system, the user terminal receives information about the ID of the measurement device and the address and ID of an access point connected to the user terminal from the access point and stores the received IDs and address.

(8) In the electric power management system, the access point is placed within the measurement device.

(9) An electric power management method of a power management server includes receiving information about the address and ID of an access point connected to a measurement device and storing the received information, sending an electric power management event message to a user terminal, receiving information about the address and ID of an access point connected to a user terminal and control information from the user terminal, receiving measured information from the measurement device, checking whether the information about the address and ID of the access point connected to the user terminal is identical with the information about the address and ID of the access point connected to the measurement device, and generating user compensation information if, as a result of the check, the information about the address and ID of the access point connected to the user terminal is found to be identical with the information about the address and ID of the access point connected to the measurement device.

(10) In the electric power management method, the reference value of the measured information is used to generate the user compensation information.

(11) In the electric power management method, receiving the information about the address and ID of the access point connected to the measurement device and storing the received information includes receiving an ID of an actuator and the information about the address and ID of the connected access point and mapping the received ID and the received information.

1. An electric power management system comprising:
a power management server;
an access point configured to communicate with the power management server and to have an address and an ID;
a power measurement device connected to the access point and configured to have an ID; and
a user terminal configured to be connected to the access point and to communicate with the power management server,
wherein the power management server comprises:
an event transmission unit configured to send an electric power management event message to the user terminal;
an information reception unit configured to receive, from the user terminal, control information of a user and information about the address and ID of the access point connected to the user terminal; and
a compensation information generation module configured to generate user compensation information by comparing the address and ID of the access point from the information reception unit with the address and ID of the access point connected to the power measurement device so that each user who participates in an event within the area covered by the access point connected to the power measurement device can be compensated for.

2. The electric power management system of claim 1, wherein the power measurement device automatically sends the ID of the power measurement device and the address and ID of the access point to the power management server when the power measurement device is installed.

3. The electric power management system of claim 1,
wherein the access point is a wireless communication device.

4. The electric power management system of claim 3,
wherein the wireless communication device is composed of one of Wi-Fi, Bluetooth, and Zigbee.

5. The electric power management system of claim 1,
wherein the access point is provided within the power measurement device.

6. (canceled)

7. The electric power management system of claim 1, wherein the user terminal receives information about the ID of the power measurement device and the address and ID of the access point connected to the user terminal from the access point and stores the received IDs and address.

8-11. (canceled)
